(19) United States
(12) Patent Application Publication
(10) Pub. No.: US 2005/0171900 A1
(43) Pub. Date: Aug. 4, 2005

(54) Automated bill presentment and payment

(76) Inventor: Onno Stefan Onneken, Bad Homburg v. d. Hohe (DE)

Correspondence Address: Mr. Onno S. Onneken, Fasanenstr. 10, Bad Homburg v. d. Hohe, 62352, DE

(21) Appl. No.: 10/769,656

(22) Filed: Feb. 2, 2004

(51) Int. Cl. G06F 17/60

(52) U.S. Cl. 705/39

(57) ABSTRACT

The Automated Bill Presentment and Payment system is an information and payment processing system which enables secure electronic processing of invoices and payments between parties who do not have an existing electronic business or payment relationship (e.g. bank direct debit) and who cannot, or prefer not to, use electronic means (internet or telephonic credit card) for payments. It utilises existing physical infrastructure (ATMs or call centres) and payment processing highways for presenting invoices and making payments. It increases the privacy, reliability and security of payments while reducing the cost of processing invoices and payments by eliminating the mailing and processing of invoices and cheques as well as the registration of credit card information through telephone operators or automated telephone answering systems.

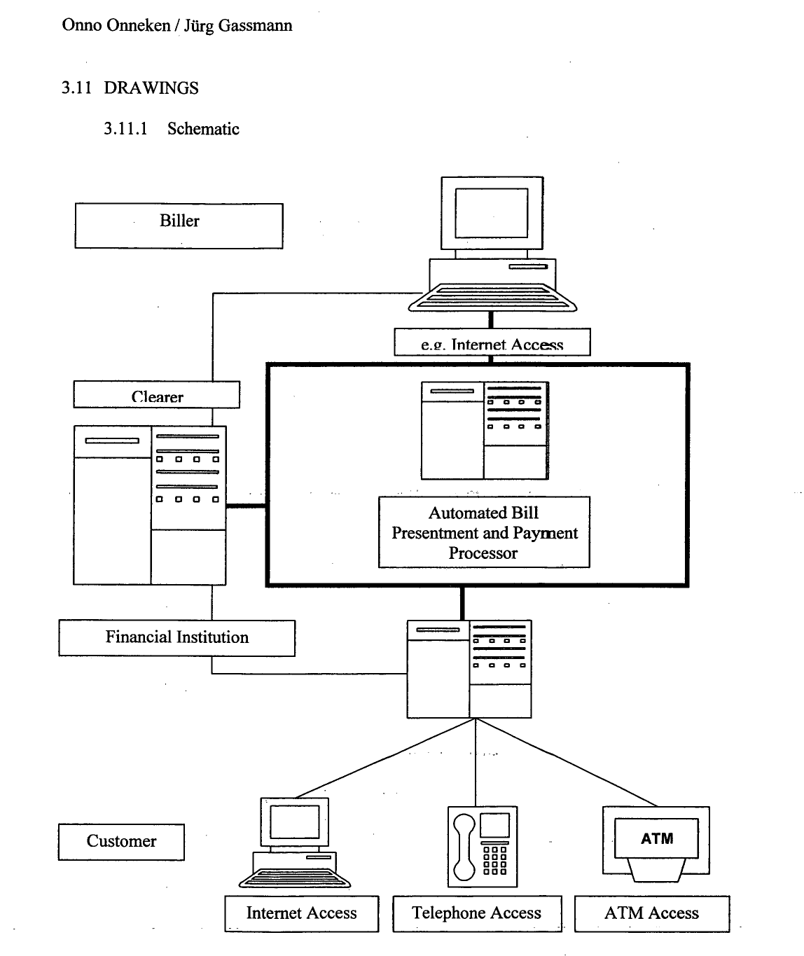

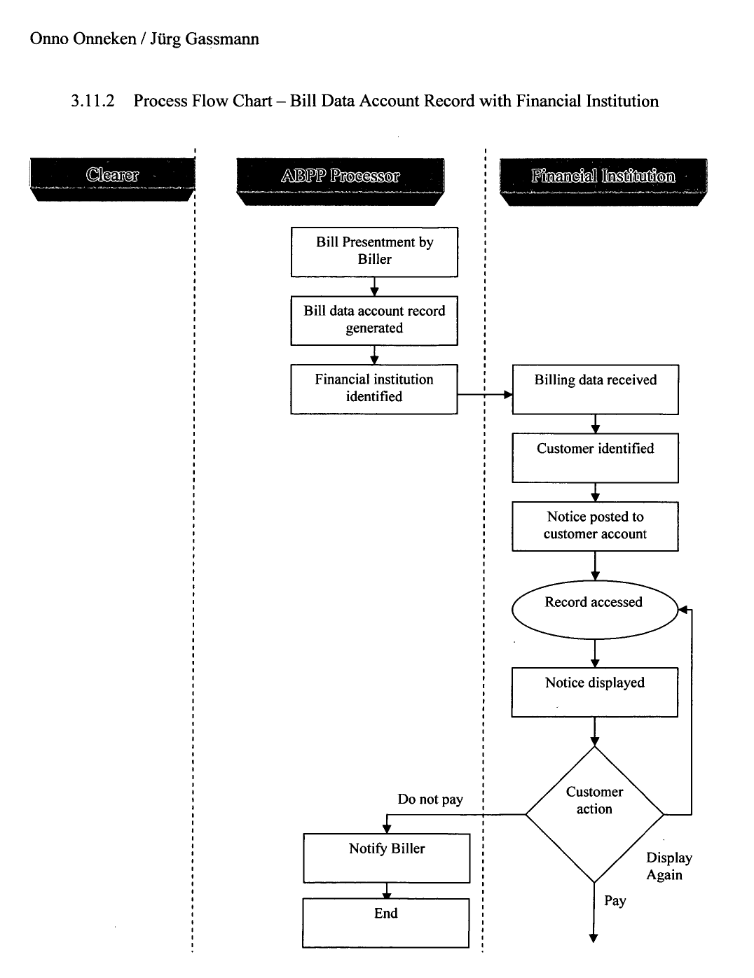

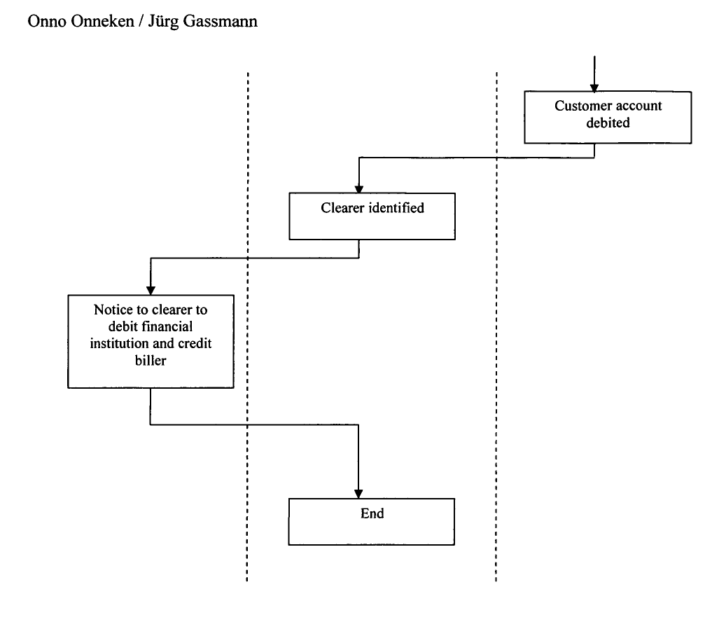

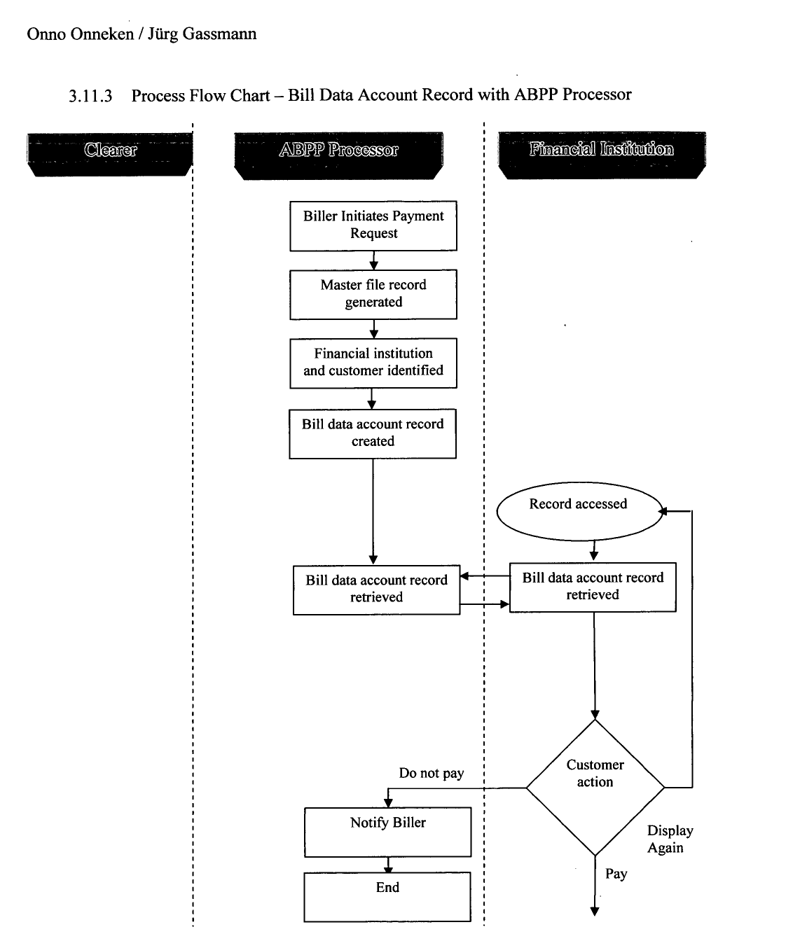

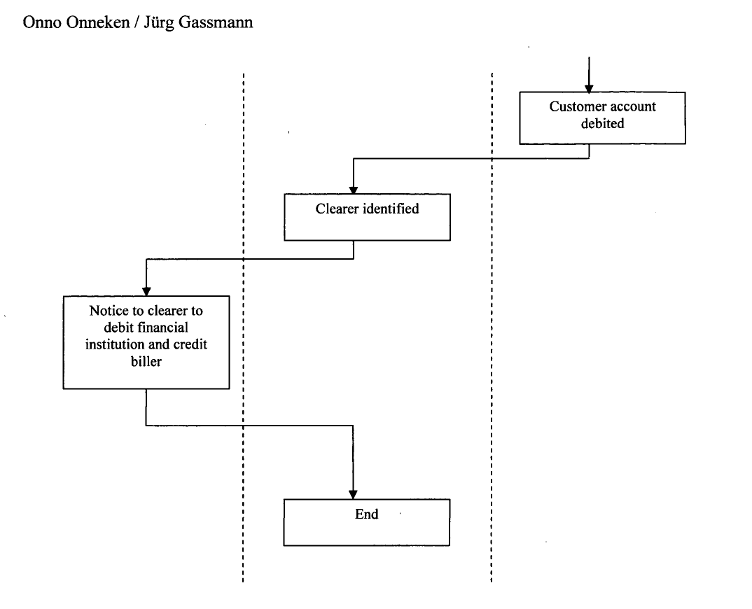

### BACKGROUND OF THE INVENTION

3.5.1 The present invention relates to an integrated information and payment processing system in which a provider of goods or services (a biller) can electronically invoice a customer via a customer's bank (financial institution or other institution), the customer can electronically pay, and the biller can, via a clearing agent appointed jointly by the biller and the financial institution, receive payments from the customer.

3.5.2 The present invention simplifies and accelerates payment processing between any provider of goods or services and any customer. It reduces the costs to billers, customers and financial institutions of processing cheques or telephonic credit card payments. It reduces the risk of innocent errors, deliberate fraud and identity theft inherent in cheque payments, and of fraud in credit card payments.

3.5.3 The system works as follows:
(a) The system is integrated into existing bank payment clearing systems (e.g. bank, credit card payments clearing) or, if no clearer is willing to operate the system, then through a separate clearer;
(b) A biller participates in the system by signing up specifically or through its bank or credit card payments clearer;
(c) A customer may elect to directly register with the ABPP system, and if it does so, receives its own customer number;
(d) At the time a biller provides goods or services to the customer, the biller obtains from the customer the financial institution identifier (name or ABA routing number/sort code) and the customer's bank account number, i.e. information commonly available on the customer's cheque but without identifying signature; alternatively, for customers participating in the ABPP system, the biller may obtain the customer's customer number;
(e) When payment is due, the biller generates an electronic invoice that is sent through the system to the customer's financial institution and is posted to the customer's account (bill data account record);
(f) If required by the customer, the same information may be transmitted to the customer by physical invoice; and
(g) Any time the customer accesses his or her account at an ATM, on the internet, over the telephone or via a bank teller, the transaction will be brought to the customer's attention; if the customer chooses, the customer can immediately process the payment by releasing the transaction.

3.5.4 Current systems for payments to occasional or regular billers (workmen, utilities, personal services) rely on either direct debit authorisations by the customer or a customer action in response to an electronic or paper invoice to the customer.

3.5.5 Direct debit authorisations are only appropriate in the case of regular billers (e.g. utilities) and are not generally acceptable to customers.

3.5.6 Where direct debits are not accepted by customers or in the case of occasional billers, the biller must generate and deliver an electronic or paper invoice to the customer. Electronic invoices are only feasible in situations where the customer has an ongoing relationship with the biller and has accepted electronic invoicing; it presupposes that the biller and the customer are connected via the internet or some other common system. Except for internet billers and certain internet banking arrangements, this option is available only to a small minority of billers. The vast majority of billers must generate a physical invoice.

3.5.7 Whether the invoice is delivered electronically or physically, payment can be made via internet or another electronic bill presentment and payment system, i.e. by generation of a cheque or other paper-based payment authorisation to a bank, or by phoning in payment authorisation against a credit card or electronic cheque.

3.5.8 Not everyone is connected to the internet, and even where an internet connection exists, the ability to make payments via the internet depends on an internet banking arrangement on the customer's side or a credit-card based arrangement, either transaction-specific or ongoing (e.g. PayPal). It also depends on a biller being set up to accept payments processed via the internet. However, not everyone is capable of, or willing to, process payments via the internet. A very large majority of payments is still processed physically, i.e. by cheque or by payment authorisation at the bank counter.

3.5.9 Cheque payments depend on the customer manually writing out a cheque, including the transaction reference with the cheque (i.e. clipping the return slip from the invoice or writing the payment reference onto the cheque) and mailing the cheque. This is costly in terms of time and out-of-pocket expense (postage), and there is an opportunity for error in any of the information (amount, transaction reference), in the transmittal (theft of letter from mailbox, insufficient or missing postage, illegible or defaced address) or in the processing (electronic or manual misreading of pre-printed or manually generated information).

3.5.10 Electronic processing depends on the customer making a telephone call to the biller's offices or to a call centre and orally conveying credit card information either to an operator, to a tape or a touch-tone processing mechanism. This method, too, has ample opportunities for errors in transmittal, but is also more open to fraud and abuse.

3.5.11 For a discussion of the current state of the art and the practical and commercial problems associated with the current state of the art, please also refer to the article “Why hasn't electronic bill presentment and payment taken off?” by Chris Stefanadis in the July/August 2002 issue of “Current Issues in Economy and Finance” issued by the Federal Reserve Bank of New York (volume 8, number 7).

### BRIEF SUMMARY OF THE INVENTION

3.6.1 The system works as follows:
(a) The system is integrated into existing bank payment clearing systems (e.g. credit card payments clearing) or, if no credit card clearer is willing to operate the system, then through a separate clearing system;
(b) A biller participates in the system by signing up specifically or through its bank or credit card payments clearer;
(c) A customer may elect to directly register with the ABPP system, and if it does so, receives its own customer number;
(d) At the time a biller provides goods or services to the customer, the biller obtains from the customer the financial institution identifier (name or ABA routing number/sort code) and the customer's bank account number, i.e. information commonly available on the customer's cheque but without identifying signature; alternatively, for customers participating in the ABPP system, the biller may obtain the customer's customer number;
(e) When payment is due, the biller generates an electronic invoice that is sent through the system to the customer's financial institution and is posted to the customer's account (bill data account record);
(f) If required by the customer, the same information may be transmitted to the customer by physical invoice;
(g) Any time the customer accesses his or her account at an ATM, on the internet, over the telephone or via a bank teller, the transaction will be brought to the customer's attention; if the customer chooses, the customer can immediately process the payment by releasing the transaction.

3.6.2 The advantage of the proposed invention over current methods is:
(a) Wider application not dependent on both biller and customer having a pre-existing agreed payment mechanism (direct debit, credit card based systems, EBPP or other);
(b) Unique identifying codes for the transaction and release of payment reduce processing errors;
(c) Even where a human or electronic interface is involved, the customer at no time transmits information which can be abused by a third party; unlike cheque payments, the customer does not match up account information and signature facsimile; unlike credit card payments, the customer does not transmit information that on its own can be abused; unlike purely internet-based payment systems, ABPP relies on existing secure communication links. All this protects the customer from identity theft and credit card fraud;
(d) The system reduces payment transaction costs by eliminating processing of physical cheques (mailing, sorting, processing, returning to customer in original of facsimile) and operation of call centres or operators, by increasing the speed of payment, by reducing errors and by reducing the scope for fraud;
(e) The system further allows a reduction in transaction costs by allowing the customer to generate and physically document the invoice, thus allowing the biller to eliminate physical generation and delivery of invoices; and
(f) The system largely utilises existing data pathways and physical equipment, thus making implementation and roll-out efficient.

### BRIEF DESCRIPTION OF SEVERAL VIEWS OF THE DRAWINGS

In the drawings:

Drawing 1 is a conceptual drawing of the place of ABPP among billers, customers, financial institutions and clearers. The bold lines denote links that are newly created for the ABPP, the thin lines represent relationships that already exist. Note that Drawing 1 assumes that one or more existing clearers will take over the payment clearing function; if this is not the case, a clearing module can be added to the ABPP.

Drawing 2 is a flow chart depicting the essential processing stages and decisions relating to an individual ABPP transaction for the situation where the invention is implemented by locating the bill data account record on the financial institution's database of customer records.

Drawing 3 is a flow chart depicting the essential processing stages and decisions relating to an individual ABPP transaction for the situation where the invention is implemented by locating the bill data account record on a database of bill data account records located with the ABPP processor.

### DETAILED DESCRIPTION OF THE INVENTION

3.8.1 The present invention is a method and apparatus for processing payments automatically. By “automatically”, it is meant that the biller can electronically create an invoice and cause it to be sent to the customer. The customer is presented all information pertinent to the bill via an electronic system (computer terminal, e.g. ATM, or at the customer's premises connected via internet) at any time the customer accesses its bank account and can authorise payment, without intervention of a human interface or transmittal of physical paper and without releasing information that is capable or abuse.

3.8.2 Drawing 1 is a schematic diagram of the invention and its positioning within its environment, showing the place of ABPP among billers, customers, financial institutions and clearers. The bold lines denote links that are newly created for the ABPP, the thin lines represent relationships that already exist. Note that Drawing 1 assumes that one or more existing clearers will take over the payment clearing function; if this is not the case, a clearing module can be added to the ABPP

3.8.3 The invention comprises:
(a) A database containing information relating to ABPP system participants;
(b) A database containing information relating to transactions initiated by an ABPP system participant;
(c) A database containing each customer's bill data account records—this database may be integrated into existing customer databases operated by financial institutions, or may be a separate database operated by the ABPP; and
(d) A processing system which generates transaction data and notifications; and (optionally) allows tracking of the progress of the transaction.

3.8.4 The ABPP system participants database will specify four categories of participants; registration with the ABPP system is a one-time event subject only to renewal or cancellation:
(a) Payment clearers—it is envisaged that one or more existing payment clearer(s) could take this role; if none does so, one or more financial institutions would be identified to take this role;
(b) Financial institutions—participation of financial institutions will ideally be based on existing clearing relationships, e.g. through credit card payment clearers. Financial institutions are identified by generic data, e.g. ABA routing number/sort code;
(c) Providers of goods and services (biller). Billers are identified by a system-specific identification number; and
(d) Optionally, a customer may elect to register with the ABPP processor. An ABPP registered customer would be identified by a specific member number instead of by the ABA routing number/sort code of its bank and its bank account number.

3.8.5 Upon registration of a clearer with the ABPP system, an interface will be created between the ABPP system and the internal system of the clearer allowing the ABPP system to send notifications to the clearer's internal system, correlate ABPP system notifications with the clearer's own database of clients, identify the relevant financial institution and the relevant biller among its clients, process payments made by the client financial institution by debiting the client financial institution's account and crediting the biller client's account.

3.8.6 It is assumed that financial institutions already have an account relationship with the or each clearer; if this is not the case, then an account relationship will be established upon registration of a financial institution with the ABPP system.

3.8.7 Upon registration of a financial institution with the ABPP system, an interface will be created between the ABPP system and the internal system of the financial institution which will allow the ABPP system to send notifications to the financial institution's internal system, correlate ABPP system notifications with the financial institution's own database of account-holders, identify the customer among its account holders, forward the notification to the account-holder/customer, process authorisations given by the account-holder/customer and process payments released by the account-holder/customer through the clearer.

3.8.8 Upon registration, a biller would identify its preferred or exclusive clearer, and enter into an account relationship with that clearer (if not already existing—e.g. regular credit card payment clearer).

3.8.9 As an event occurring outside the ABPP system, at the time of the provision of goods or services to a customer, the biller would obtain from the customer the customer's bank details (name and, if possible, ABA routing number/sort code) and account number. This information is printed on cheques and is commonly exchanged. Alternatively, a customer may prefer to register with the ABPP, in which case the customer need only give the biller its customer number.

3.8.10 At the time of invoicing, the biller interfaces with the ABPP system via existing hardware and an existing data pathway (e.g. biller's computer system via internet) and enters into the system:
(a) The biller's system-specific identification (along with system access code);
(b) The financial institution's identifier (ABA routing number/sort code of customer bank);
(c) The customer's identifier (bank account number);
(d) A description of the transaction (e.g. description of the items—goods or services—to which the invoice relates);
(e) The transaction amount; and
(f) Optionally, any further information relevant to the biller, e.g. customer number, invoice number and related accounting and internal payment tracking and control data—this information will not be processed by the ABPP system, but appended to the transaction record and reproduced to the biller in system notifications.

3.8.11 The ABPP system then generates a transaction record which is entered onto the master transaction database and creates:
(a) A unique transaction number identifying the transaction on the master database, and which is notified to the biller; and
(b) A unique transaction short code, which is not notified to the biller.

3.8.12 As an event occurring outside the ABPP system, the biller may send to the customer a physical or electronic invoice containing the transaction data (except for the transaction code). Due to the feature described in section 3.8.18, this step may be omitted (thereby further reducing physical processing and mailing costs).

3.8.13 The system notifies to the financial institution all the data set out in sections 3.8.10 and 3.8.11.

3.8.14 Through its interface with the financial institution's internal system, the ABPP system will automatically identify the customer and forward the information to the customer's bill data account record on the financial institution's database of customer records (see Drawing 2). Alternatively, if the bill data account record is held on a database operated by the ABPP processor, then the information is entered into that database (see Drawing 3).

3.8.15 At any time the customer accesses his or her account, the information will be displayed. Access can occur:
(a) At an ATM—depending on system configuration, the information may be displayed automatically or upon request (i.e. key entry option on introduction of ATM card);
(b) When the account is accessed over the internet (where relevant);
(c) When the account is accessed over the telephone (where relevant); or
(d) When the account is accessed by a bank teller during a bank counter transaction.
   Customer access can occur directly with the financial institution, directly with the ABPP processor, or through a third party intermediary such as a call centre, an ATM operator, etc.

3.8.16 Where the bill data account record is located on the financial institution's database, the ABPP system will comprise a procedure to be included in the financial institution's systems to display the bill data when the customer accesses his or her account. Where the bill data account record is located with the ABPP processor, the ABPP system will comprise a procedure whereby the bill data account record is automatically retrieved from the ABPP processor and displayed to the customer at any time the customer accesses his or her account.

3.8.17 It is suggested that the financial institution's internal systems offer the customer an option to (i) authorise the payment; (ii) not make the payment, but request that the notification be re-displayed the next time the customer accesses the account; or (iii) not make the payment, and request that the notification not be re-displayed.

3.8.18 Physical documentation of the payment request (paper invoice) is typically of concern to the customer, not the biller (e.g. vouchers for inclusion in tax returns). Where the biller does not generate a physical invoice, the customer may itself generate a physical invoice by printing the notification (ATM printer, account statement, other).

3.8.19 The customer or the bank teller either select or key in the transaction number or otherwise release payment.

3.8.20 Where access is through a bank teller, security of the transaction can be maintained by requiring a customer signature on the authorisation to the bank teller to key in the transaction code (security on customer entry is assured due to the fact that the customer will only gain access to the account information after keying in the relevant PIN).

3.8.21 The customer may also choose not to take any action or decline to pay.

3.8.22 Once the financial institution receives the system's release, the financial institution's internal system automatically debits the customer's account and credits the clearer's account. This is recorded on the ABPP system master transaction database.

3.8.23 Through the interface with the clearer, the ABPP system then causes the clearer's internal system to automatically debit the financial institution's account with the clearer and to credit the biller's account with the clearer. This is recorded on the master transaction database.

3.8.24 The final step of putting the funds at the biller's disposition occurs pursuant to the procedures established between the biller and its clearer. If the ABPP processor will act as clearer, then it is envisaged that these procedures will follow current market practice.

3.8.25 Once the payments are completed, the transaction record is locked.

3.8.26 This process is described in diagrammatic form in Diagram 2.

3.8.27 In addition to the required notifications generated by the master database at described points (events) in the processing of the transaction, the system can be configured so that ABPP system participants can actively access the master database and obtain transaction status information at any time.

3.8.28 The customer is not obliged to pay via the system; a customer may still pay by cheque, cash or other means. The ABPP system in this case only generates notifications to the customer. The notification does not act as a credit card debit enquiry or as an electronic payment request.

3.8.29 It is envisaged that it will be up to the biller to take into account events such as payments made by other means, or if a notification is cancelled or not acted upon within a certain period. If the transaction has not been previously locked on the master database, the biller will have to re-enter a transaction on the ABPP system if payment is to be processed via the system, or solicit payment otherwise.

### SEQUENCE LISTING

Not applicable

3.9.1. An information processing system comprising:
(a) A database including a plurality of personal records of participants in the ABPP, each of said personal records containing (i) a personal identifier identifying the record as being that of (aa) the recipient of payments (biller) or (bb) a financial institution acting as processor of payments and interface with that financial institution's database of personal records of its customers or (cc) a customer participating directly in the ABPP; and (ii) identifying a clearing agent for clearing payments made to a biller by a financial institution acting on behalf of a customer;
(b) Processing means for retrieving a personal record of the biller from said personal data base based on said personal identifier, for retrieving a personal record of the said financial institution and for interfacing with the said financial institution's database of personal records with the purpose of identifying and retrieving the customer's personal record;
(c) A master file for storing transaction data.

3.9.2. An information processing system according to claim 3.9.1 comprising:
(a) Processing means responsive to a processing request initiated by a biller containing (i) a personal identifier of the biller for performing said processing; (ii) a personal identifier of the financial institution (bank sort code or ABA routing number); (iii) a personal identifier of the customer (account number); (iv) a transaction description and (v) a specification of the transaction amount; for a customer directly registered with the ABPP system, item (ii) and (iii) may be replaced by the customer's customer number;
(b) Processing means responsive to the processing request allocating to the processing request (i) an individual identifying transaction record number; and (ii) an individual transaction code;
(c) Processing means responsive to the processing request identifying the clearing agent for said transaction; and
(d) Processing means to update the master file to include transaction data and match transaction data to system participants.

3.9.3. An information processing system according to claim 3.9.1 comprising processing means responsive to the processing request causing the ABPP to generate a notification to the relevant financial institution which will cause the financial institution's internal system to update the record of the customer on the financial institution's database to include the bill data account record comprising the information set out in claims 3.9.2(a) and 3.9.2(b) and generate a notification to the customer of the transaction request containing all relevant data, whether such customer record is accessed by the customer directly through the financial institution or through an intermediary interposed between the customer and the financial institution (see Drawing 2).

3.9.4. Alternatively to procedure set out in claim 3.9.3, an information processing system according to claim 3.9.1 (see Drawing 3) comprising:
(a) a database including a plurality of bill data account records containing the information set out in claim 3.9.1(a); and
(b) processing means responsive to the biller's processing request causing the ABPP to generate a bill data account record on the ABPP processor's database of bill data which will include the information set out in claims 3.9.2(a) and 3.9.2(b).

3.9.5. For the mode of implementation described in claim 3.9.3:
(a) an information processing system according to claim 3.9.1 comprising processing means for interfacing with the financial institution's internal system to enable the ABPP to cause the financial institution's internal system to deliver the transaction data to the customer responsive to a customer's request to access the customer's record on the financial institution's database (ATM transaction, telephone transaction, internet transaction, counter transaction); and
(b) an information processing system according to claim 3.9.1 comprising:
(i) Processing means for interfacing with the financial institution's internal system to enable the ABPP to cause the financial institution's internal system to be responsive to a customer's input releasing payment or requiring another action;
(ii) Processing means for interfacing with the financial institution's internal system to enable the ABPP to cause the financial institution's internal system to be responsive to a customer's input of the data set forth in claim 3.9.5(b)(i);
(iii) in the case where the customer has released the payment, updating the customer's personal record on the database of the financial institution (debiting the customer's account with the financial institution) and authorising the financial institution to make the payment to the biller; and
(iv) Processing means to update the master file to include the fact that a payment has been authorised.

3.9.6. For the mode of implementation described in claim 3.9.4:
(a) an information processing system according to claim 3.9.1 comprising processing means for updating the ABPP processor's database of bill data account records;
(b) an information processing system according to claim 3.9.1 comprising processing means for interfacing with the internal system of the financial institution (and/or the financial institution's technical execution intermediary) responsive to a customer's request to access the customer's record on the financial institution's database (ATM transaction, telephone transaction, internet transaction, counter transaction) causing the financial institution's internal system to retrieve the relevant bill data account record from the ABPP processor's database of bill data account records and display the information in the bill data account record to the customer; and
(c) an information processing system according to claim 3.9.1 comprising:
(i) Processing means for interfacing with the financial institution's internal system to enable the ABPP to cause the financial institution's internal system to be responsive to a customer's input releasing payment or requiring another action;
(ii) Processing means for interfacing with the financial institution's internal system to enable the ABPP to cause the financial institution's internal system to be responsive to a customer's input of the data set forth in claim 3.9.6(c)(i);
(iii) In the case where the customer has released the payment, updating the customer's personal record on the database of the financial institution (debiting the customer's account with the financial institution) and authorising the financial institution to make the payment to the biller; and
(iv) Processing means to update the master file to include the fact that a payment has been authorised.

3.9.7. An information processing system according to claim 3.9.1 comprising:
(a) Processing means responsive to the notification delivered under claim 3.9.5(b)(iv) or claim 3.9.6(c)(iv) generating a notification to the clearer's internal system allowing the ABPP to cause the clearer's internal system to retrieve the financial institution's record on the clearing agent's database of personal records and to retrieve the biller's record on the clearing agent's database;
(b) Processing means responsive to the notification delivered under claim 3.9.5(b)(iv) or claim 3.9.6(c)(iv) for identifying on the clearer's internal system (i) the biller; (ii) the financial institution; (iii) the individual identifying transaction record number; and (iv) the transaction amount;
(c) Processing means responsive to the notification delivered under claim 3.9.7(b) allowing the ABPP to cause the clearer's internal system to update (i) the personal record of the financial institution on the clearing agent's database of personal records (debiting the financial institution's account) and (ii) the personal record of the biller on the clearing agent's database of personal records (crediting the biller's account); and
(d) Processing means to update the master file to include the fact that a payment has been processed by the clearing agent and that the transaction has been completed.

3.9.8. An information processing system according to claim 3.9.1 updating the master transaction record to log transaction events and be responsive to ABPP system participant status queries.

3.9.9. An integrated information processing system comprising:
(a) A communications network;
(b) An information supply host connected to said communication network and including a master personal database for storing personal data of participants in the ABPP system and for storing individual transaction data; and
(c) One or more processing hosts connected to said communication network and connecting the information supply host and the distributed processing apparatus (biller computer terminals connected to the communications network via internet; financial institution ATMs and counter terminals connected to the communications network via proprietary networks or other pathways; customer computer terminals connected to the communications network via internet).
